(19) United States
(12) Patent Application Publication
(10) Pub. No.: US 2015/0239024 A1
(43) Pub. Date: Aug. 27, 2015

(54) Apparatus and Method for On-site Disposal of Trace Chemo Containers and Waste, Expired Pharmaceuticals, and Sharps Containers and Sharps

(71) Applicant: Felix Jakobi, Long Beach, CA (US)

(72) Inventor: Felix Jakobi, Long Beach, CA (US)

(21) Appl. No.: 14/190,927

(22) Filed: Feb. 26, 2014

(51) Int. Cl. B09B 3/00

(52) U.S. Cl. CPC B09B 3/0075; B09B 3/0083

(57) ABSTRACT

Improved apparatus and method for on-site disposal of waste material including trace chemo, expired pharmaceuticals, and sharps, without the use of chemicals or incineration, and without requiring the waste material to be packaged and shipped to a location where incineration is allowed. The waste material is dropped into a high temperature crucible. The crucible is heated to at least 1,400 degrees Fahrenheit by inductive heating to disintegrate the waste material. The crucible is filled with nitrogen which depletes any oxygen entering the crucible to prevent oxidization of the waste material in the crucible.

### BACKGROUND OF THE INVENTION

The present invention relates to disposal of hospital waste and in particular to disposal of trace chemo, expired pharmaceuticals, and sharps waste material.

Hospital waste material including trace chemo waste material, expired pharmaceuticals, and sharps waste material poses a threat to any human or animal which may come into contact with this waste material. As a result, the disposal of trace chemo waste material, expired pharmaceuticals, and sharps waste material is highly regulated. Known methods for disposal include incineration or dangerous chemicals. In many areas such disposal methods are bared by regulations, and the trace chemo waste material, expired pharmaceuticals, and sharps waste material must be packaged and transported at significant expense. Such transportation present additional potential risks in the event of an accident. Therefore, an apparatus and method are needed for on-site disposal of trace chemo, expired pharmaceuticals, and sharps waste material.

### BRIEF SUMMARY OF THE INVENTION

The present invention addresses the above and other needs by providing an improved apparatus and method for on-site disposal of waste material including trace chemo, expired pharmaceuticals, and sharps, without the use of chemicals or incineration, and without requiring the waste material to be packaged and shipped to a location where incineration is allowed. The waste material is dropped into a high temperature crucible. The crucible is heated to at least 1,400 degrees Fahrenheit by inductive heating to disintegrate the waste material. The crucible is filled with nitrogen which depletes any oxygen entering the crucible to prevent oxidization of the waste material in the crucible.

In accordance with one aspect of the invention, there is provided an apparatus and method for on-site disposal of trace chemo, expired pharmaceuticals, and sharps waste material which includes a very high temperature crucible for disintegrating trace chemo material and for sterilizing sharps waste. The crucible is preferably an inductive furnace operating at about 1,500 degrees Fahrenheit. Both the trace chemo material and trace chemo container, expired pharmaceuticals, and sharps containers, are disintegrated in a single step reducing material handling requirements.

In accordance with another aspect of the invention, there is provided an apparatus and method for on-site disposal of trace chemo, expired pharmaceuticals, and sharps waste material. The method includes providing a continuous flow of nitrogen into the crucible, inductively heating a crucible to operating temperature, placing containers containing waste material above the crucible, opening two crucible loading doors, releasing the waste material into the crucible, immediately closing the two crucible loading doors, holding the waste material in the crucible for a period of time to disinfect the waste material, opening a release door of the disposal machine, releasing the disinfected waste material from the disposal machine, and depositing the disinfected waste material into a waste storage container.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 shows a perspective view of a trace chemo, expired pharmaceuticals, and sharps waste material disposal machine according to the present invention.

FIG. 2A shows a side view of a waste material disposal machine according to the present invention.

FIG. 2B shows a side view of the waste material disposal machine according to the present invention.

FIG. 2C shows a bottom view of the waste material disposal machine according to the present invention.

FIG. 3 shows a crucible and inductive coil of the waste material disposal machine according to the present invention.

FIG. 4 shows electrically conducting straps around the crucible according to the present invention.

FIG. 5 shows a cross-sectional view of the crucible taken along line 5-5 of FIG. 3 according to the present invention.

FIG. 6 is a method for processing waste material according to the present invention.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

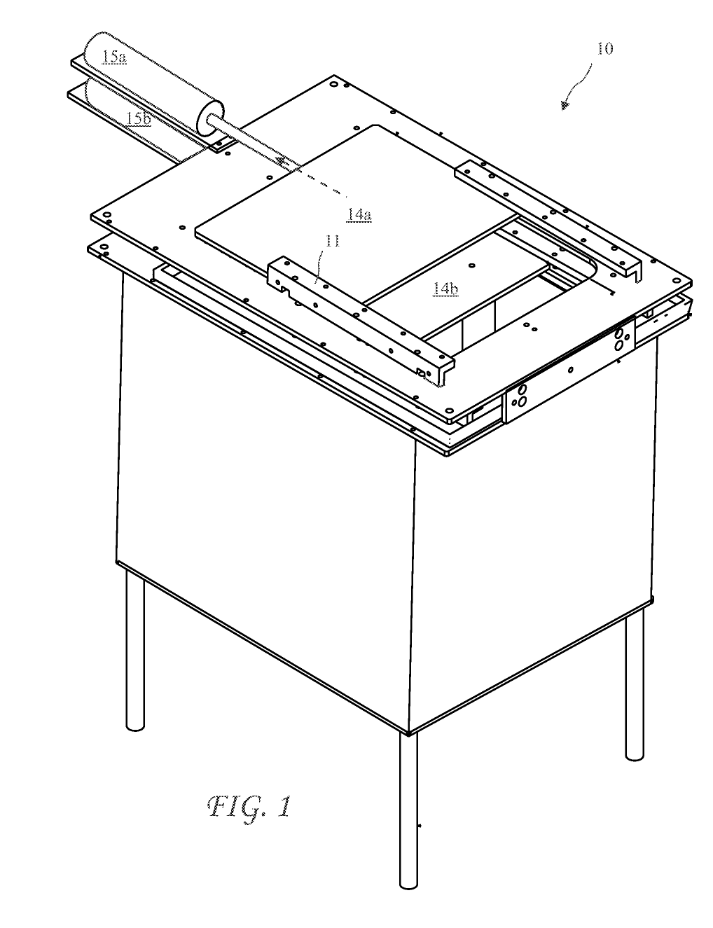

A perspective view of a trace chemo, expired pharmaceuticals, and sharps waste material disposal machine 10 according to the present invention is shown in FIG. 1. The disposal machine 10 processes trace chemo waste material and sharps waste material. The trace chemo waste material, the sharps waste material, and their containers (e.g., yellow trace chemo containers) are subjected to extreme heat in the disposal machine 10 to destroy all present contaminates.

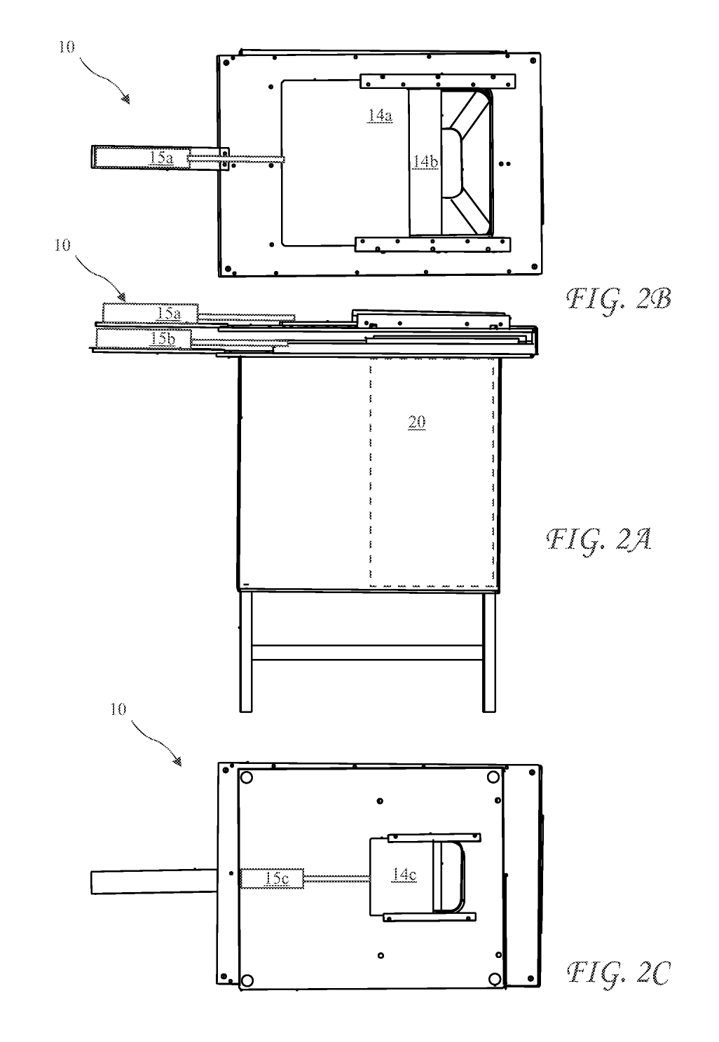

A side view of a waste material disposal machine is shown in FIG. 2A, a side view of the waste material disposal machine 10 is shown in FIG. 2B, and a bottom view of the waste material disposal machine 10 is shown in FIG. 2C. The disposal machine 10 includes a main waste processing section including a crucible 20 residing in one side of the disposal machine 10. The waste material is exposed to very high temperature in the crucible 20 where the trace chemo waste and yellow container and the sharps and sharps containers are disintegrated.

Loading pneumatic cylinders 15a and 15b simultaneously actuate loading doors 14a and the waste material drops into the disposal machine 10, and in particular, into the crucible 16. The doors 15a and 15b are vertically separated by about six inches and the bottom door 14b seals against the top of the crucible 20. Waste containers (for example, yellow trace chemo containers) are released into the crucible 20 for disintegration along with the trace chemo waste material. A bottom release door 14c is opened by a pneumatic cylinder 15c after a period of time and releases disinfected waste material from the disposal machine 10. The second loading door 14b cooperates with seals to prevent or reduce the entry of oxygen into the crucible 20 during operation.

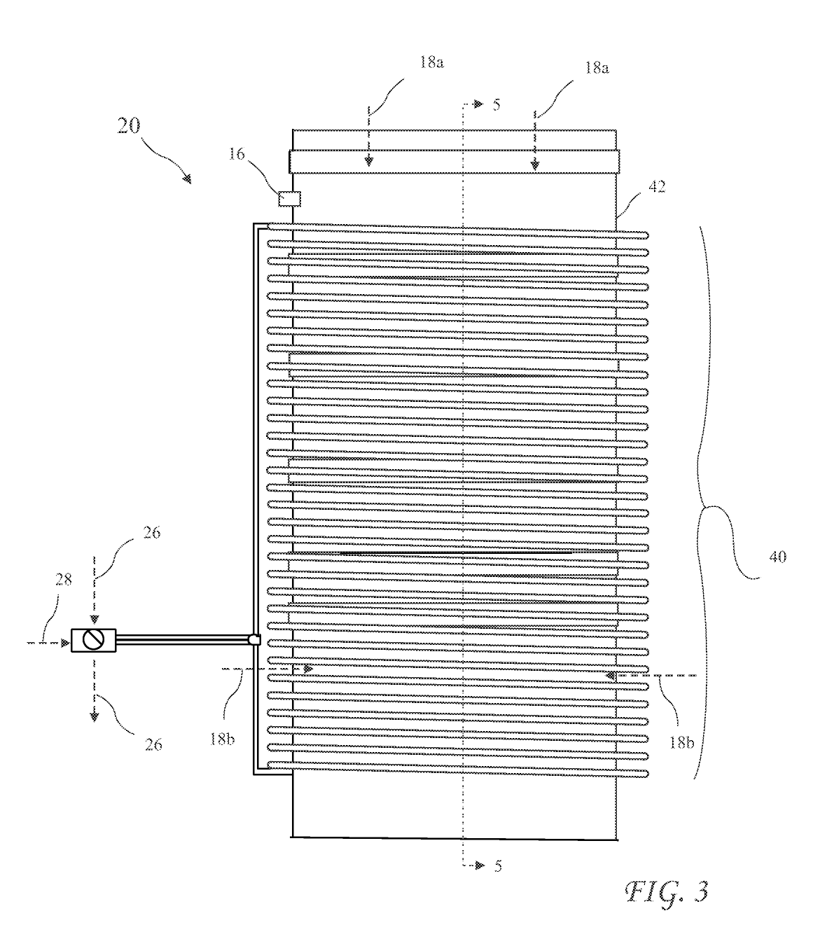

The crucible 20 and an inductive coil 20 of the waste material disposal machine 10 is shown in FIG. 3. The inductive coil 20 received electrical current to create a magnetic field around a crucible liner 42. The liner 42 is preferably stainless steel and more preferably 304 stainless steel. The inductive coil 40 preferably is made from tubing and also serves to cool the exterior of the crucible by carrying a flow of coolant. A temperature sensor 16 measures the internal temperature of the crucible 20. Flows of nitrogen are introduced into the crucible to react with any oxygen present inside the crucible to deplete the oxygen to prevent the waste material from reacting with the oxygen. The nitrogen is preferably provided through the door 15a and into the crucible base, preferably four flows 18a through the 15a and two flows 18b into the base of the crucible. The coil 40 has a height H, length L and width D. The height H is preferably about 30 inches, the length L is preferably about 26 inches, and the width W is preferably about 21 inches. A coolant flow 26 is carried to and from the coil 40 and electrical current 28 is provided to the coil 40.

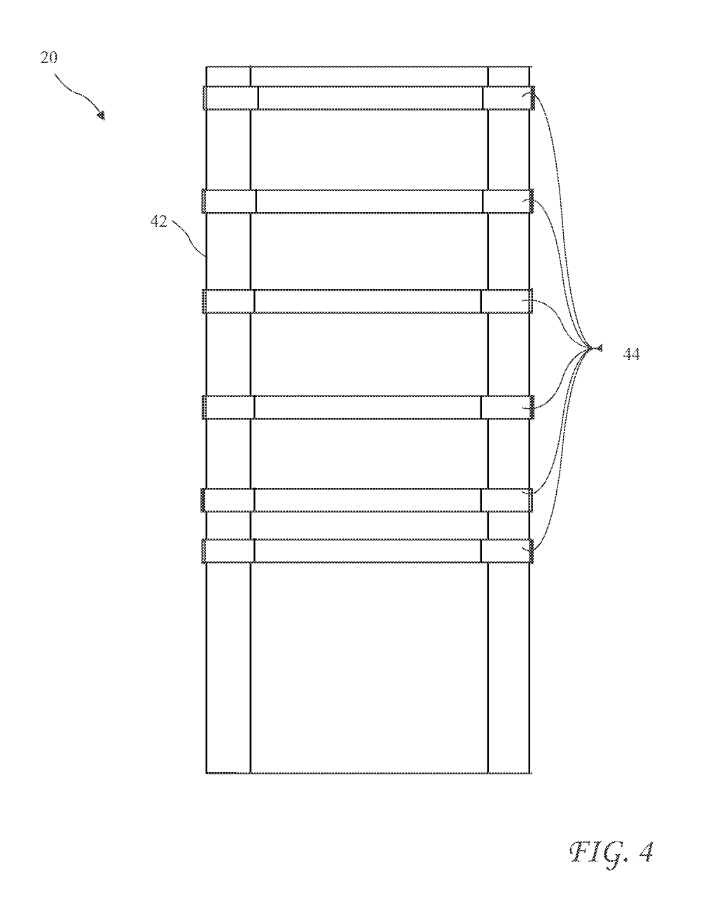

Electrically conducting straps 44 are shown attached around the crucible liner 42 in FIG. 4. The straps 44 inductively cooperate with the magnetic field created by the inductive coil 40 to heat the crucible liner 42. The straps 44 are preferable 1 by ½ inch copper straps.

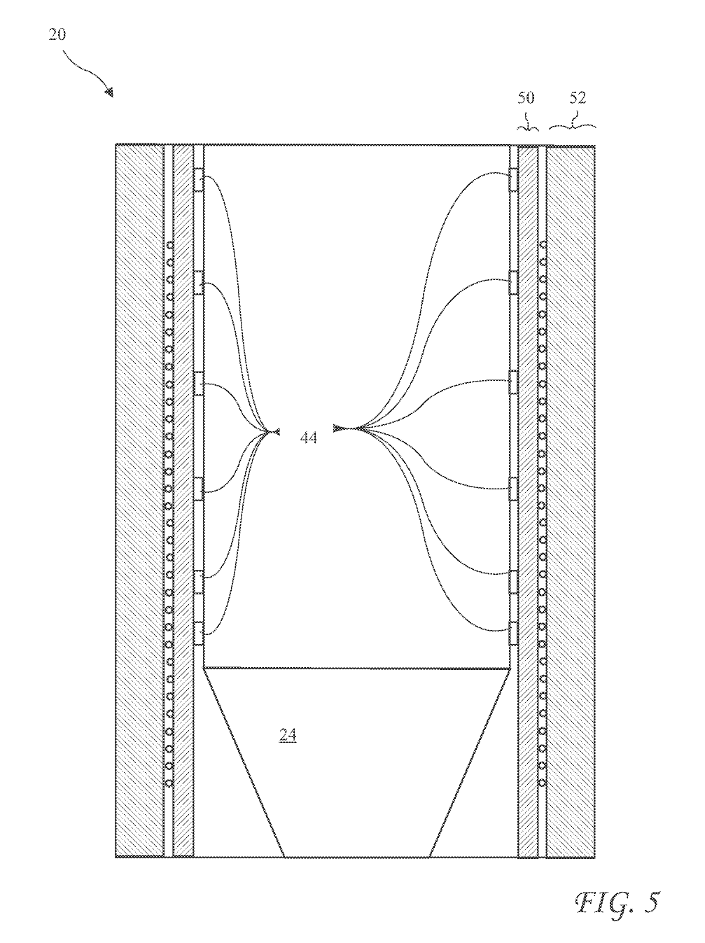

A cross-sectional view of the crucible 20 taken along line 5-5 of FIG. 3 is shown in FIG. 5. An inner layer of insulation 50 resides between the inductive coil 40 and the straps 44 and an outer layer of insulation 52 resides around the inductive coil 40. A chute 24 recessed into the bottom of the crucible 20 receives the processed material from the disposal machine 10 and releases the processed material for disposal. An auger may be present to carry the processed material (e.g., non toxic ash) to a drop where it may be dropped into a common waste disposal container.

An example of a suitable induction furnace for use as the crucible 20 is an EKPHeat 50/10 manufactured by Ambrell Precision Inductive Heating in Scottsville, N.Y. The EKPHeat 50/10 operates on 50 kW at 5-15 kHz.

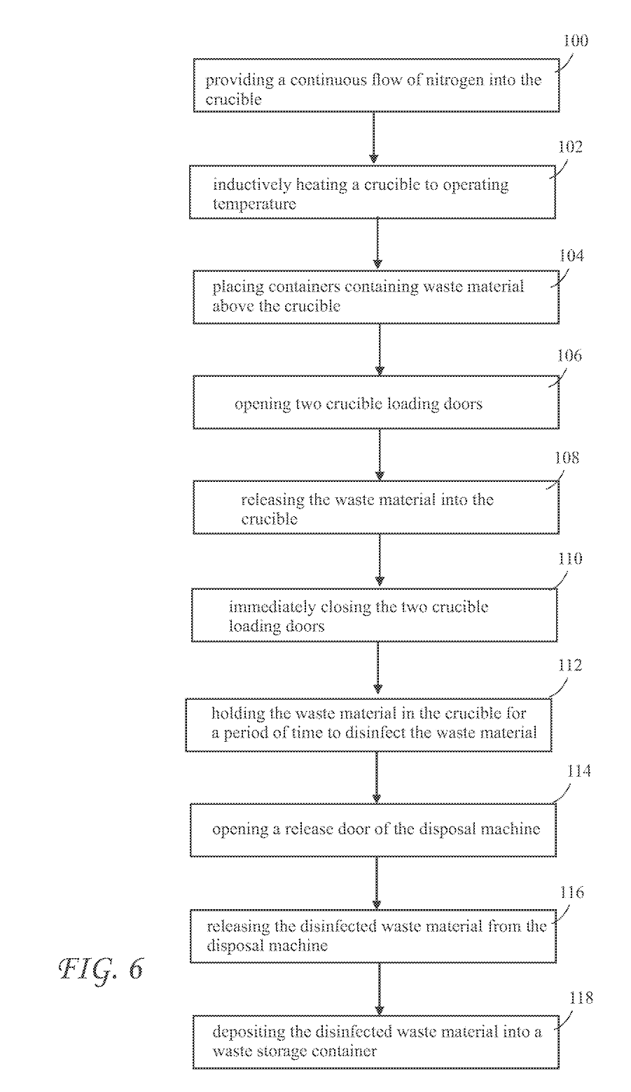

A method for disposing of trace chemo, expired pharmaceuticals, and sharps waste material is shown in FIG. 6. The method includes: providing a continuous flow of nitrogen into the crucible at step 100, inductively heating a crucible to operating temperature at step 102, placing containers containing waste material above the crucible at step 104, opening two crucible loading doors at step 106, releasing the waste material into the crucible at step 108, immediately closing the two crucible loading doors at step 110, holding the waste material in the crucible for a period of time to disinfect the waste material at step 112, opening a release door of the disposal machine at step 114, releasing the disinfected waste material from the disposal machine at step 116, and depositing the disinfected waste material into a waste storage container at step 118.

The method may further include cooling the exterior of the crucible by circulating coolant through tubing which also creates the magnetic field for inductive heating.

Expanding to more detail, the method operator steps including:

actuating a start button;

providing power to the crucible heating element (the crucible preferably remains heated until shut down at an end of the current shift);

waiting for the crucible to reach operating temp, preferably within five minutes;

placing a waste material container in a load station area;

positioning the container above the disposal machine thereby actuating a limit switch to verify that the container is in place;

starting an operating cycle;

starting the auger;

starting the after burner (which includes a pilot light which lights a gas burner);

actuating a release switch to actuate a loading pneumatic cylinder which opens a loading door;

releasing the container and contents to drop into the disposal machine and into the crucible;

immediately closing the two crucible loading doors (e.g., in two to three seconds);

providing a dwell time (e.g., about one minute) for the container and contents to completely disintegrating the container and contents at the crucible operating temperature;

after the dwell time has expired, opening a release door under the crucible;

releasing the disinfected material into a chute under the disposal machine;

closing the release door; and

carrying disinfected waste material to a waste storage container.

Further, if the temperature in the crucible drops below 1,400 degrees Fahrenheit, operation is suspended until the temperature rises above 1,400 degrees Fahrenheit.

While the invention herein disclosed has been described by means of specific embodiments and applications thereof, numerous modifications and variations could be made thereto by those skilled in the art without departing from the scope of the invention set forth in the claims.

I claim:

1. A method for disinfecting waste containers and waste material, the method comprising:
heating a crucible to an operating temperature of at least 1,400 degrees Fahrenheit;
positioning waste material above the crucible;
opening a door between the container and the crucible;
releasing the waste material into the crucible;
immediately closing the door;
holding the waste material in the crucible for a period of time to disinfect the waste material to produce disinfected material;
releasing the disinfected material from the crucible; and
depositing the disinfected material to a waste container.

2. The method of claim 2, wherein heating a crucible to operating temperature comprises heating the crucible to about 1,600 degrees Fahrenheit.

3. The method of claim 1, wherein heating the crucible to operating temperature comprises heating the crucible by an induction coil heater to operating temperature.

4. The method of claim 3, further including providing cooling on an exterior of the crucible.

5. The method of claim 4, wherein providing cooling on an exterior of the crucible comprises providing cooling through electrically conductive tubes, where in the electrically conductive tubes also provide the induction coil heater.

6. The method of claim 1, further including providing a flow of nitrogen into the crucible to deplete oxygen in the crucible.

7. The method of claim 1, wherein depositing the disinfected material to a waste container includes carrying the disinfected material in a linear conveyor to the waste container.

8. The method of claim 7, wherein carrying the disinfected material in a linear conveyor to the waste container comprises carrying the disinfected material in an auger to the waste container.

9. The method of claim 1, wherein positioning waste material above the crucible comprises positioning waste containers containing:
trace chemo waste;
trace chemo waste containers;
pharmaceutical waste;
sharps; and
sharps containers.

10. The method of claim 1, wherein holding the waste material in the crucible for a period of time to disinfect the waste material comprises holding the waste material in the crucible for at least one minute to disinfect the waste material.

11. The method of claim 1, further including, if the temperature in the crucible drops below 1,400 degrees Fahrenheit, suspending operation until the temperature rises above 1,400 degrees Fahrenheit.

12. A method for disinfecting waste containers and waste material, the method comprising:
providing a flow of nitrogen into a crucible having a stainless steel crucible liner;
providing electrical current to an induction coil heater comprising a coil of tubing residing around the stainless steel liner and spaced outside the stainless steel liner by thermal insulation;
creating a magnetic field around the crucible;
heating conductive bars attached to the stainless steel liner to heat the crucible;
providing a flow of coolant through the tubing;
heating the crucible to an operating temperature of at least 1,400 degrees Fahrenheit;
measuring a temperature inside the stainless steel liner and if the temperature in the stainless steel liner drops below 1,400 degrees Fahrenheit, suspending operation until the temperature rises above 1,400 degrees Fahrenheit;
positioning waste material above the crucible;
opening a door between the container and the crucible;
releasing the waste material into the crucible;
immediately closing the door;
holding the waste material in the crucible for a period of time to disinfect the waste material to produce disinfected material;
releasing the disinfected material from the crucible; and
depositing the disinfected material to a waste container.

13. A method for disinfecting waste containers and waste material, the method comprising:
providing a continuous flow of nitrogen into a crucible having a stainless steel crucible liner;
providing electrical current to an induction coil heater comprising a coil of tubing residing around the stainless steel liner and spaced outside the stainless steel liner by thermal insulation;
creating a magnetic field around the crucible;
heating conductive bars attached to the stainless steel liner to heat the crucible;
providing a flow of coolant through the tubing;
heating the crucible to an operating temperature of at least 1,400 degrees Fahrenheit;
measuring a temperature inside the stainless steel liner and if the temperature in the stainless steel liner drops below 1,400 degrees Fahrenheit, suspending operation until the temperature rises above 1,400 degrees Fahrenheit;
positioning waste material above the crucible;
opening two parallel overlapping doors between the container and the crucible, a lower door of the two doors sealing the crucible;
releasing the waste material into the crucible;
immediately closing the door;
holding the waste material in the crucible for a period of time to disinfect the waste material to produce disinfected material;
releasing the disinfected material from the crucible; and
depositing the disinfected material to a waste container.
